(19) United States
(12) Patent Application Publication
(10) Pub. No.: US 2011/0295466 A1
(43) Pub. Date: Dec. 1, 2011

(54) Seating Status Detection Apparatus and Occupant Monitoring System for a Moving Body

(75) Inventors: Masahiro Ostu, Aichi (JP); Kota Yamada, Aichi (JP)

(73) Assignee: MASPRODENKOH KABUSHIKIKAISHA, Aichi (JP)

(21) Appl. No.: 13/147,626

(22) PCT Filed: Feb. 8, 2010
(86) PCT No.: PCT/JP2010/051818

§ 371 Date: Aug. 3, 2011

(30) Foreign Application Priority Data
Feb. 6, 2009 (JP) 2009-026541

(51) Int. Cl. G01N 25/00; B60R 21/015

(52) U.S. Cl. 701/45; 374/45

(57) ABSTRACT

There is provided a seating status detection apparatus that includes: an antenna element that receives thermal noise radiated from an occupant seated on a seat in a moving body; and a recognition device that recognizes the occupant seated on the seat based on a reception level of the thermal noise received by the antenna element.

### CROSS-REFERENCE TO RELATED APPLICATION

This Application is a Section 371 National Stage Application of International Application No. PCT/JP2010/051818, filed Feb. 8, 2010, and published as WO 2010/090321 A1 on Aug. 12, 2010, not in English.

### TECHNICAL FIELD

The present invention relates to a seating status detection apparatus that detects a seating status of an occupant on a seat in a moving body such as a car, and an occupant monitoring system for a moving body provided with the seating status detection apparatus.

### BACKGROUND ART

Conventionally, as a seating status detection apparatus of this type, the following configuration has been known: a pressure sensor (or a load sensor) is provided inside a seat; this sensor detects a pressure (load) applied to the seat when an occupant is seated, to detect the fact that the occupant is seated (see, for example, Patent Documents 1, 2 and others).

As apparatus that detects a seating posture, as a seating status of an occupant, of an occupant, the following configuration has been known: an image around a seat is captured with an optical camera (specifically, a CCD camera, an infrared camera, etc.); an image of an occupant is extracted from the captured image, thereby recognizing the seating posture (see, for example, Patent Documents 3, 4 and others).

### PRIOR ART DOCUMENTS

### Patent Documents

Patent Document 1: Unexamined Japanese Patent Application Publication No. 2008-221971
Patent Document 2: Unexamined Japanese Patent Application Publication No. 2005-186878
Patent Document 3: Unexamined Japanese Patent Application Publication No. 2001-213268
Patent Document 4: Unexamined Japanese Patent Application Publication No. 2007-198929

### DISCLOSURE OF THE INVENTION

### Problems to be Solved by the Invention

As in the former configuration described above, when the seating status detection apparatus is constituted of a pressure sensor or the like to detect a pressure or a load applied to a seat when an occupant is seated, the following problem may arise: that is, it cannot be distinguished between when an occupant is actually seated and when an item which is not an occupant is placed on a seat; thus, if the item is placed on the seat, it may be falsely detected that an occupant is seated.

On the other hand, when an image around a seat is captured with a camera as in the latter configuration described above, it is possible to distinguish between when an occupant is seated on a seat and when an item is placed on the seat by analyzing the captured image. Therefore, it would not be falsely detected that an occupant is seated.

However, in order to capture an image, which is clear enough to identify an occupant from the captured image, with an optical camera inside a moving body, a light source illuminating around the seat to be captured and a control device that controls lighting of the light source are necessary; in this case, there is a problem in which the seating status detection apparatus may become costly.

Moreover, in the case of imaging an occupant with a camera, if a shielding object (for example, a newspaper, a magazine, etc.) that shields lights exists between the camera and the occupant, an image of the occupant cannot be correctly captured; therefore, a problem arises in which a seating status of the occupant cannot be determined based on the capture image.

The present invention has been made in view of the above problems. An object of the present invention is to provide a seating status detection apparatus capable of detecting a seating status of an occupant in a moving body such as a car by distinguishing between the occupant and other items without using an optical camera, and an occupant monitoring system for a moving body provided with the seating status detection apparatus.

### Means for Solving the Problems

A first aspect of the present invention to achieve the above object includes an antenna element and a recognition device. The antenna element receives thermal noise radiated from an occupant seated on a seat in a moving body. The recognition device recognizes the occupant seated on the seat based on a reception level of the thermal noise received by the antenna element.

A second aspect of the present invention is that, in the seating status detection apparatus according to the first aspect of the present invention, there is provided an antenna device in which a plurality of the antenna elements are arranged in a planar manner; the recognition device recognizes a posture of the occupant seated on the seat based on the reception levels of the thermal noises received by the plurality of antenna element.

Then, a third aspect of the present invention is that, in the seating status detection apparatus according to the second aspect of the present invention, the antenna device is installed in at least one of a seating section, a backrest section, and a headrest of the seat.

A fourth aspect of the present invention is that, in the seating status detection apparatus according to the second aspect or the third aspect of the present invention, the antenna device is constituted of a planar antenna in which the plurality of antenna elements are arranged in a distributed manner on a flexible substrate, and is provided between an occupant-side surface fabric of the seat and a cushion material inside of the seat.

Then, a fifth aspect of the present invention is that, in the seating status detection apparatus according to any one of the second to the fourth aspects of the present invention, there is provided a posture determination device. The posture determination device determines whether or not the posture of the occupant recognized by the recognition device is within a predetermined normal range. When the posture of the occupant is not in the predetermined normal range, the posture determination device notifies the occupant or an external device that the posture of the occupant is not in the predetermined normal range.

Further, a sixth aspect of the present invention is that, in the seating status detection apparatus according to the fifth aspect of the present invention, the posture determination device determines whether or not the posture of the occupant recognized by the recognition device is a normal posture which allows an airbag provided for the seat to be safely activated. The posture determination device transmits a signal that permits an operation of the airbag to an external airbag control device when the posture of the occupant is the normal posture, while the posture determination device transmits a signal that inhibits the operation of the airbag to the airbag control device when the posture of the occupant is not the normal posture.

Further, a seventh aspect of the present invention is an occupant monitoring system provided in a moving body to monitor statuses of occupants riding in the moving body. This system includes the seating status detection apparatus according to any one of the first to the sixth aspects of the present invention, provided in each of a plurality of seats to be seated by occupants to be monitored. The system also includes a monitoring apparatus provided in a vicinity of a seat of an administrator who operates the moving body. The monitoring apparatus obtains results of recognition of the occupants from the recognition devices, each constituting each of the seating status detection apparatuses, in accordance with an input command from the administrator. Then, the monitoring apparatus notifies the administrator of the obtained results.

A eighth aspect of the present invention is that, in the occupant monitoring system for a moving body according to the seventh aspect of the present invention, the monitoring apparatus is capable of measuring a number of occupants riding in the moving body based on the results of recognition obtained from the recognition devices of the respective seating status detection apparatuses in accordance with the input command from the administrator, and notifying the administrator of a result of the measurement.

A ninth aspect of the present invention is that, in the occupant monitoring system for a moving body according to the seventh or the eighth aspect of the present invention, there is provided the seating status detection apparatus according to any one of the second to the sixth aspects of the present invention as the seating status detection apparatus. The monitoring apparatus is capable of obtaining seating postures of the occupants on the seats on which the occupants are seated, from the recognition devices of the respective seating status detection apparatuses in accordance with the input command from the administrator, and notifying the administrator of the obtained seating postures.

### Effects of the Invention

The seating status detection apparatus according to the first aspect of the present invention includes the antenna element as a sensor that detects a seating status of an occupant on a seat. The antenna element receives thermal noise radiated from an occupant seated on a seat. Based on a reception level of the thermal noise received by the antenna element, the recognition device recognizes the occupant seated on the seat.

That is, thermal noise radiated from a human body having a temperature is greater than thermal noise from items; therefore, in the present invention, the antenna element receives the thermal noise and a reception level of the thermal noise is detected, thereby recognizing the occupant seated on the seat.

Because of this, in the seating status detection apparatus of the present invention, unlike in the case of a conventional device provided with a pressure sensor or a load sensor as a sensor for recognizing a seating status, it would not be falsely recognized that the occupant is seated when an item is placed on the seat. Thus, detection accuracy of a seating status by the present apparatus can be further improved than that by the conventional device.

Moreover, in the seating status detection apparatus of the present invention, unlike in the case of a conventional device configured to recognize a seating status of an occupant from an image around the seat captured by an optical camera, it is not necessary to provide a light source that illuminates around the seat to be imaged and a control device that controls lighting of the light source. Therefore, manufacturing costs in the present apparatus can be lower than that in the conventional device.

In addition, even when a shielding object that optically shields an item exists between the occupant and the present apparatus, it is possible to recognize the occupant seated on a seat as long as the shielding object does not shield thermal noise (in other words, high frequency electromagnetic wave). Therefore, detection accuracy of a seating status by the present apparatus can be further improved than that by this conventional device as well.

Next, the seating status detection apparatus according to the second aspect of the present invention includes, as a sensor that detects a seating status of an occupant on a seat, an antenna device (so-called planar antenna) in which a plurality of the above-explained antenna elements are arranged in a planar manner (in other words, arranged in a two-dimensional array). Based on reception levels of thermal noise received by the plurality of antenna elements constituting the antenna device, the recognition device recognizes a posture of an occupant seated on a seat.

That is to say, if the antenna device (so-called planar antenna) in which the plurality of the antenna elements are arranged in a planar manner is used, it is possible to obtain a two-dimensional image data in which each of the antenna elements correspond to one pixel. Therefore, in the seating status detection apparatus according to the second aspect of the present invention, this antenna device is utilized to capture an image of a seat so as to recognize, not only the fact that the occupant is seated on the seat, but also a seating posture of the occupant on the seat, from the captured image (in other words, a signal level of each of the pixels).

The result of the recognition by the recognition device can be used to improve safety of occupants in a moving body; for example, it is determined whether or not a seating posture of an occupant is safe and if not safe, an alarm is given; or when it is detected that an occupant is nodding off based on a periodical change in a seating posture of the occupant, an alarm is given.

In the case where the antenna device constituting the so-called planar antenna is used to recognize a seating posture of an occupant as explained above, the following configuration is necessary to ensure accuracy of the recognition. That is, a directional characteristic (beam) of each of the antenna elements needs to be narrowed, so that the antenna elements arranged adjacent to each other in the antenna device do not receive thermal noise radiated from the same part of the occupant. However, there is a limit to how narrow the directivity (beam) of each of the antenna elements can be.

In view of the above, in the seating status detection apparatus in the second aspect of the present invention, the above-explained antenna device may be preferably installed in at least one of a seating section, a backrest section, and a headrest of a seat as in the third aspect of the present invention.

When configured as above, the antenna device can be closely arranged to the occupant so as to reduce the directivity (beam) of each of the antenna elements. This makes it possible to improve recognition accuracy of a seating posture, more easily and at lower cost than by making the directivity (beam) of each of the antenna elements be narrow.

That is, when an image of an occupant is captured by receiving thermal noise radiated from the occupant with a plurality of antenna elements, a receiving frequency of each of the antenna elements may be in a microwave band (specifically, millimeter waves of EHF band (so-called millimeter waves; frequency: 30 GHz to 300 GHz) or centimeter waves of SHF band (quasi-millimeter waves; frequency: 3 GHz to 30 GHz)), so as to allow capturing of the image. However, in an airbag according to the third aspect of the present invention, it is possible to use, as an antenna element, an antenna element for SHF band with which directivity is lower than that for millimeter waves; therefore, manufacturing costs for an antenna device can be reduced.

As an antenna element capable of receiving thermal noise, a tapered slot antenna has been known. In the tapered slot antenna, however, it is necessary to configure that a length of the antenna element (depth along an arriving direction of electric waves) is about four times as long as wavelength λ of electric waves. The depth of the antenna element (and further, an antenna array in which the respective antenna elements are arranged in a planar manner) would be several centimeters even when millimeter waves are used as the receiving frequency.

In a posture determination device for airbag according to the third aspect of the present invention, a receiving frequency of the antenna element can be in SHF band which is lower than millimeter waves. Therefore, as in the fourth aspect of the present invention, the antenna device can be configured by a planar antenna in which a plurality of antenna elements are arranged in a distributed manner on a flexible substrate. As a result, it is possible to reduce a thickness of the antenna device.

In this case, as in the fourth aspect of the present invention, when the antenna device (planar antenna) is provided between an occupant-side surface fabric of the seat and a cushion material inside of the seat, the respective antenna elements can be closely attached to an occupant seated on the seat. Thereby, a posture of the occupant can be more accurately recognized from the captured image obtained from the respective antenna elements.

In the seating status detection apparatus according to the second to fourth aspects of the present invention, the antenna device (planar antenna) is used as a sensor for detecting a seating status; in the antenna device, antenna elements are arranged in a planar manner. In this case, the antenna device may be provided at a plurality of positions: the seating section of the seat, and at least one of the backrest section and the headrest of the seat.

In other words, when configuration as above, the plurality of the antenna devices are used so as to allow the recognition device to detect a position of an occupant's hip or thighs placed on the seating section of the seat, and a position of the occupant's back or head, respectively, placed on the backrest section or the headrest of the seat. Thus, based on these results of the detections, it is possible to recognize a seating posture of the occupant more precisely.

Moreover, in the seating status detection apparatus according to the second to fourth aspects of the present invention, the posture determination device may be provided as in the fifth aspect of the present invention. The posture determination device determines whether or not the posture of the occupant recognized by the recognition device is within a predetermined normal range, and if not, notifies the occupant or an external device that the posture is not in the normal range. In other words, the above configuration makes it possible to encourage the occupant to correct the posture and therefore, to improve safety of a moving body while operating.

In the posture determination device constituted as in the sixth aspect of the present invention, it is possible to minimize an injury of the occupant caused by inflation of an airbag when the airbag provided to a seat of a moving body is activated.

In the occupant monitoring system in the seventh aspect of the present invention, the following is possible: in a moving body that operates carrying passengers thereon, such as a bus, a train, a ship, an airplane, etc., seats to be seated by the passengers are to be monitored; when each of these seats is provided with the seating status detection apparatus according to one of the first to sixth aspects of the present invention and the monitoring apparatus is provided in a vicinity of a seat of an administrator (such as a driver, a cabin attendant, etc.) who operates the moving body, the administrator can confirm seating statuses of the passengers on the seats while being in the own seat. Accordingly, the occupant monitoring system of the present invention makes it possible to provide a preferred system that monitors get-on-and-off statuses and seating statuses of passengers in a moving body that carries passengers.

Moreover, in the occupant monitoring system according to the seventh aspect of the present invention, when the monitoring apparatus is configured to, as in the eighth aspect of the present invention, measure a number of occupants riding in the moving body based on a result of a recognition obtained from the recognition device of each of the seating status detection apparatuses, to notify the administrator, it is possible, for example, to easily confirm a number of occupants before leaving in a sightseeing bus, etc.

In the ninth aspect of the present invention, the seating status detection apparatus according to one of the second to sixth aspects of the present invention is utilized as a seating status detection apparatus to be provided on a seat to be monitored. In this case, the monitoring apparatus can obtain a seating posture of the occupant on the seat on which the occupant is seated from the recognition device of each of the seating status detection apparatus, and notify the administrator of the obtained seating posture. As a result, after confirming the seating posture of the occupant, the administrator can give an alarm to the occupant (especially, passenger) without being disrespectful.

### BRIEF DESCRIPTION OF THE DRAWINGS

FIG. 1 is a block diagram showing a configuration of the entire posture determination device according to the first embodiment.

FIG. 2 is an explanatory view showing an arrangement of planar antennas inside a seat.

FIGS. 3A and 3B are explanatory views showing a configuration of the planar antenna in which antenna elements are formed on a substrate.

FIG. 4 is a block diagram showing a configuration of a circuit in the planar antenna.

FIG. 5 is a flowchart showing a posture determination process executed by the posture determination device.

FIGS. 6A and 6B are explanatory views showing occupants seated on seats in a normal posture and recognized states of the occupants.

FIG. 7 is an explanatory view showing a car seat for children which is mounted facing rearward.

FIG. 8 is an explanatory view showing a schematic configuration of a bus in which an occupant monitoring system of the second embodiment is installed.

FIGS. 9A and 9B are block diagrams showing, respectively, a configuration of a detection apparatus and a configuration of a monitoring apparatus, provided in the bus in FIG. 8.

FIG. 10 is a flowchart showing a number-of-boarding-persons confirmation process and an occupant presence determination process, respectively, executed by the monitoring apparatus shown in FIG. 9B and the detection apparatus shown in FIG. 9A.

FIG. 11 is a flowchart showing a seating posture confirmation process and a posture determination process executed by the monitoring apparatus shown in FIG. 9B and the detection apparatus shown in FIG. 9A.

### DESCRIPTION OF REFERENCE NUMERALS

seat, 4 . . . seating section, 6 . . . backrest section, 8 . . . headrest, 10 . . . antenna element, 10a . . . through hole, 12 . . . first antenna, 14 . . . second antenna, 16 . . . third antenna, 20 . . . posture determination device, 22,90 . . . CPU, 24,92 . . . ROM, 26,94 . . . RAM, 28 . . . antenna control unit, 30 . . . input unit, 32 . . . image memory, 34,96 . . . communication unit, 42 . . . LNA, 43 . . . BPF, 44 . . . selector, 45 . . . wave detector, 46 . . . signal processor, 48 . . . temperature sensor, 50 . . . multilayer substrate, 52 . . . earth face, 54 . . . output line, 56 . . . power-supply line, 58 . . . switching signal line, 59 . . . terminal unit, 600 . . . airbag control device, 62 . . . engine control device, 64 . . . alarm device, 66 . . . seating status detection apparatus, 68 . . . determination device, 70 . . . car seat for children, 72 . . . bus, 74 . . . driver's seat, 76 . . . seat, 80 . . . monitoring apparatus, 82 . . . input device, 84 . . . display device, 86 memory device, 98 . . . input/output unit.

### BEST MODE FOR CARRYING OUT THE INVENTION

An embodiment of the present invention will be hereinafter described with reference to the drawings.

### First Embodiment

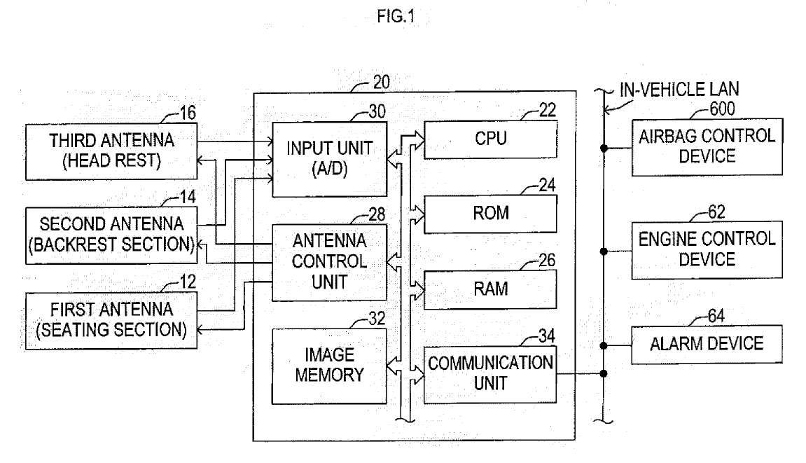

FIG. 1 is a block diagram showing a configuration of the entire posture determination device for airbag according to the first embodiment to which the present invention is applied.

The posture determination device for airbag (hereinafter, simply referred to as “posture determination device”) 20 of the present embodiment is provided in each seat of a vehicle and configured to: image an occupant seated on the seat by receiving thermal noise radiated from the occupant, thereby recognizing a posture of the occupant; based on a result of the recognition, determine whether or not the occupant is seated in a normal posture in which an airbag can be safely activated; and allow activation of the airbag when the occupant is seated in the normal posture. The posture determination device 20 is mainly composed of a microcomputer including a CPU 22, a ROM 24, a RAM 26, and others.

The posture determination device 20 is provided with: an antenna control unit 28 that operates each of three antenna devices (a first antenna 12, a second antenna 14, and a third antenna 16) provided to image an occupant; an input unit 30 that receives and A/D converts outputs from the respective antennas 12, 14, and 16; an image memory 32 that stores data inputted via the input unit 30 as image data; and a communication unit 34 that is connected to an in-vehicle LAN (specifically, a communication line or a wireless communication line).

The communication unit 34 is used to establish a communication with various electronic devices, such as an airbag control device 600, an engine control device 62, and an alarm device 64, etc., installed in a vehicle via the in-vehicle LAN.

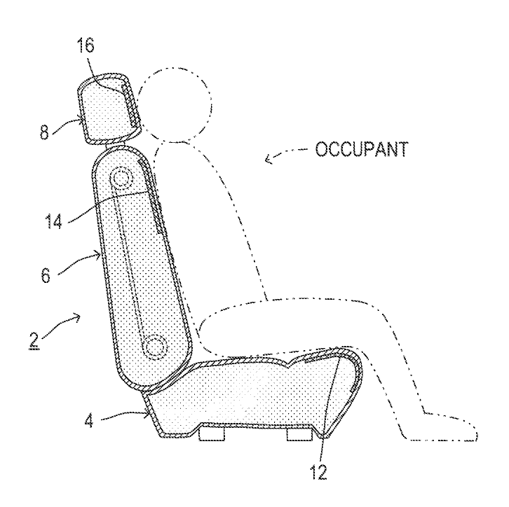

As shown in FIG. 2, the above three antennas 12, 14, and 16 are provided as follows: the first antenna 12 is provided in a seating section 4 of a seat 2; the second antenna 14 is provided in a backrest section 6 of the seat 2; and the third antenna 16 is provided in a headrest 8 of the seat 2.

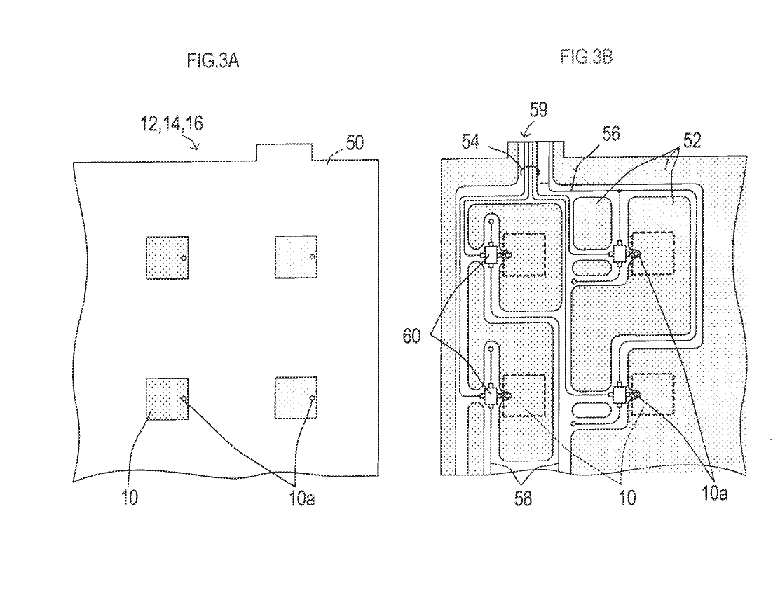

Specifically, as shown in FIGS. 3A and 3B, each of the antennas 12, 14, and 16 is configured to be a deformable planar antenna which includes a plurality of antenna elements 10 and an earth face 52. The antenna elements 10 are arranged in a two-dimensional array on a surface of a flexible multilayer substrate 50, and constitute a patch antenna. The earth face 52 consists of conductors stacked on a back side of the multilayer substrate 50 and is adapted to be a reflective face to each of the antenna elements 10.

The antennas 12, 14, and 16 are provided, respectively, in the seating section 4, the backrest section 6, and the headrest 8 of the seat 2, between an occupant-side surface fabric and an inner cushion material. The first antenna 12 is provided at a front end portion of the seating section 4, which is opposite to the backrest section 6, in a curved manner from an upper face portion to a front-end face portion.

As the flexible multilayer substrate 50, a multilayer substrate made of fluororesin, polyimide, PET, polyester, PPE, or the like can be used. In the case that the antennas 12, 14, and 16 are arranged at a center part inside of the seat 2, it is not necessary to configure the antennas 12, 14, and 16 to be deformable. Accordingly, a hard multilayer substrate made of ceramics, glass epoxy, or the like can be used as the multilayer substrate 50.

As shown in FIG. 3B, the multilayer substrate 50 constituting each of the antennas 12, 14, and 16 includes an output line 54, a power-supply line 56, a switching signal line 58 which are appropriately formed in a back side and an intermediate layer (not shown) of the multilayer substrate 50. In addition, an IC 60 is mounted for each of the antenna elements 10 on the back side of the multilayer substrate 50.

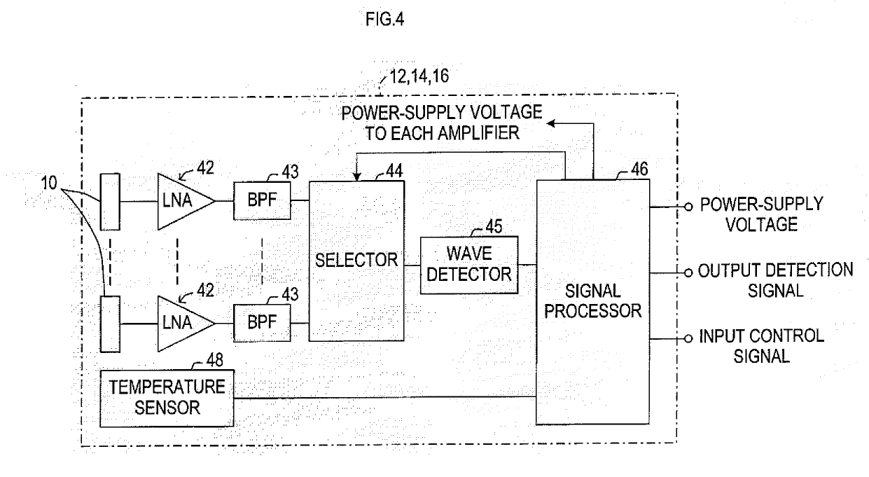

The IC 60 is an integrated circuit including a low-noise amplifier (LNA) 42, a band-pass filter (BPF) 43, and a selector 44 shown in FIG. 4. The IC 60 has a received-signal input terminal which is connected with the antenna element 10 via a through hole 10a. The IC 60 also has a received-signal output terminal, an electric-power supply terminal, and a switching-signal input terminal, which are connected with the output line 54, the power-supply line 56, and the switching signal line 58, respectively.

The multilayer substrate 50 constituting each of the antennas 12, 14, and 16 is provided with a terminal unit 59 from which the output line 54, the power-supply line 56, and the switching-signal line 58 are drawn out to the outside. A wave detector 45 and a signal processor 46 shown in FIG. 4 are connected to the multilayer substrate 50 via the terminal unit 59.

Inside the IC 60 provided in each of the antenna elements 10, a received signal from the antenna element 10 is amplified by the LNA 42 and unnecessary signal components are extracted by the BPF 43. Consequently, only the received signal within a predetermined frequency band for capturing an occupant image (SHF band in the present embodiment) is inputted to the selector 44.

As shown in FIG. 4, a switching signal is inputted to the selector 44 from the signal processor 46 via the switching signal line 58. Based on the switching signal, one of the plurality of antenna elements 10 is selected. Then, the received signal from the selected antenna element 10 is outputted to the wave detector 45 from the selector 44 via the output line 54.

The wave detector 45 detects waves of the received signal to generate a detection signal representing a voltage level of the received signal. The signal processor 46 then outputs the detection signal to the input unit 30 of the posture determination device 20.

Based on a control signal inputted from the antenna control unit 28 of the posture determination device 20, the signal processor 46 supplies a power-supply voltage to each of the ICs 60 (in other words, the LNA 42 and the selector 44 within the IC 60) via the power-supply line 56. The signal processor 46 outputs the switching signal to the selector 44 within each of the ICs 60. Thereby, the received signals from each of the antenna elements 10 are sequentially outputted to the wave detector 45 from the respective ICs 60; correspondingly, the detection signals outputted from the wave detector 45 are sequentially outputted to the input unit 30 of the posture determination device 20.

Each of the antennas 12, 14, and 16 is provided with a temperature sensor 48 that detects temperatures of the antenna elements 10. Detection signals from the temperature sensor 48 are also outputted to the input unit 30 of the posture determination device 20 from the signal processor 46.

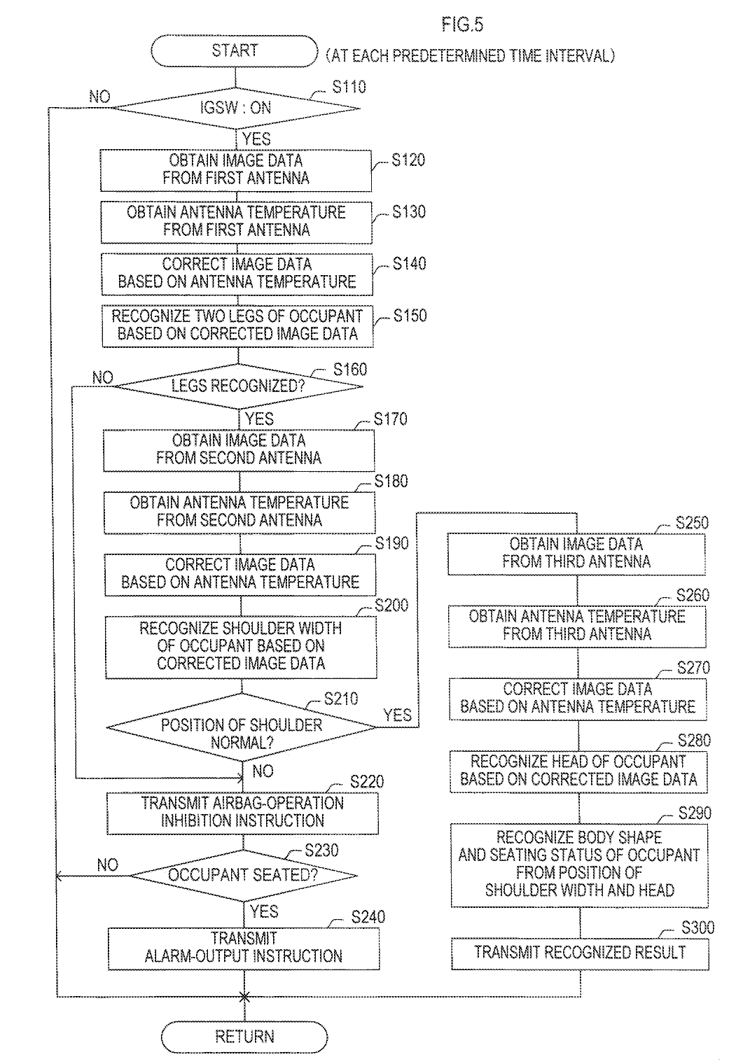

Next, FIG. 5 is a flowchart showing a posture determination process which is repeatedly executed at each predetermined time interval by the CPU 22 of the posture determination device 20.

As shown in FIG. 5, when this process is started, first in S110 (S represents a step), a state of an ignition switch (IGSW) is obtained from an engine control device 62 to determine whether the IGSW is in ON state or not at present (i.e., at present, whether or not the engine of the vehicle is operating).

If the IGSW is in OFF state and thus, the engine is stopped, the present process is ended. On the other hand, if the IGSW is in ON state and thus, the engine is operating, the present process proceeds to S120 to obtain image data from the first antenna 12.

Specifically, in S120, a control signal is outputted to the signal processor 46 of the first antenna 12 via the antenna control unit 28, so as to sequentially obtain signal levels of received signals from each of the antenna elements 10 constituting the first antenna 12. The obtained signal levels are sequentially stored in the image memory 32. Thereby, the image data of the seating section 4 obtained from the first antenna 12 is stored.

Then, when the image data is obtained from the first antenna 12 in S120, the present process proceeds to S130. In S130, a temperature of the first antenna 12 is obtained from the temperature sensor 48 provided in the first antenna 12. In the next S140, the image data stored in the image memory 32 is corrected based on the obtained antenna temperature.

That is, thermal noise from an occupant, which is received by the antenna elements 10, changes depending on temperatures of the antenna elements 10; therefore, in S140, based on a difference between the antenna temperature and a pre-set reference temperature, a value of each pixel constituting the image data (i.e., wave detection voltage of each of the antenna elements 10 by the wave detector 45) is corrected.

When the correction of the image data obtained by the first antenna 12 is completed in S140, in S150, two legs of the occupant are recognized in the corrected image data.

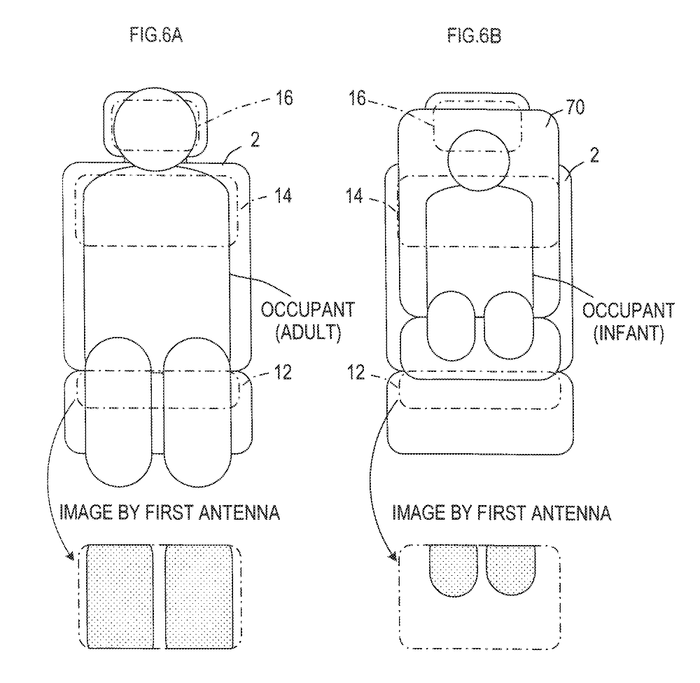

Specifically, as shown in FIGS. 6A and 6B, if the occupant is seated on the seat 2 in a normal posture, two legs are to be captured in the image obtained by the first antenna 12. Regardless of whether the occupant is an adult or an infant on a car seat for children 70 placed on the seat 2 facing forward, two legs are to be captured with a mere difference in length of legs.

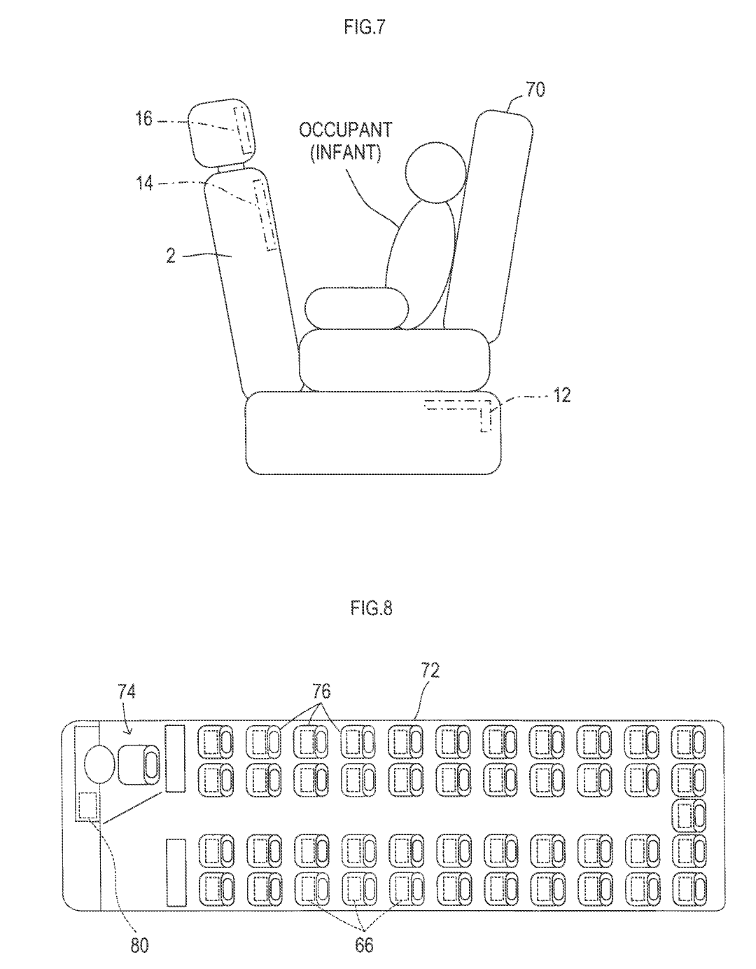

On the other hand, if the occupant is seated askew on the seat 2 or if an infant is seated on the car seat for children 70 placed facing rearward as illustrated in FIG. 7, the first antenna 12 cannot capture two legs in a predetermined direction.

In view of the above, in order to confirm a seating status of the occupant, it is recognized in S140 whether or not the occupant's two legs are captured by processing the image data obtained by the first antenna 12.

In the subsequent step S160, it is determined whether or not the two legs are recognized by the processing in S150. If the two legs are not recognized, the present process proceeds to S220. In S220, an airbag-operation inhibition instruction is outputted to the airbag control device 600, thereby stopping the airbag from being activated.

On the other hand, if it is determined in S160 that the two legs are recognized based on the image data obtained by the first antenna 12, the present process proceeds to S170, S180, and then S190. In S170, S180, and S190, imaged data is obtained from the second antenna 14 provided in the backrest section 6 of the seat 2 and then corrected base on a temperature, in the same manner as in S120, S130, and S140, respectively.

Then, in S200, a shoulder width of the occupant is recognized based on the image data, which is obtained via the second antenna 14, of the backrest section 6. In S210, it is determined whether or not a center of the shoulder width is greatly displaced to right or left in relation to the seat, thereby determining whether or not the occupant is seated in a substantially aligned manner with the backrest section 6.

When it is determined in S210 that the center of the shoulder width is substantially in the center of the seat 2 and thus, the occupant is correctly seated, the present process proceeds to S250. If not, the present process proceeds to S220 to output an airbag-operation inhibition instruction to the airbag control device 600, thereby stopping the airbag from being operated.

After the airbag-operation inhibition instruction is outputted in S220, it is determined in S230 whether or not the occupant is seated on the seat 2 based on the image data obtained via either the first antenna 12 or the second antenna 14.

That is to say, when the occupant is seated on the seat 2, an image of a part of the occupant must have been captured by the first antenna 12 and the second antenna 14. Therefore, in this case, whether or not the occupant is seated on the seat 2 is determined based on the captured image data; and if not seated, the present process is ended, while if seated, the present process proceeds to S240.

In S240, the alarm device 64 is made to generate an alarm and then the present process is ended. The alarm indicates that the fact that, since a posture of an occupant seated on the seat is incorrect, an activation of the airbag is stopped. This alarm may be made by an audio guidance or lighting of an alarm lamp, or both.

In S250, S260, and S270, imaged data is obtained from the third antenna 16 provided in the headrest 8 of the seat 2 and then corrected base on a temperature, in the same manner as in S120, S130, and S140, respectively.

Then, in S280, a head of the occupant is recognized based on the image data, which is obtained via the third antenna 16, of the headrest 8. In the subsequent S290, based on a result of the recognition of the head and the occupant's shoulder width, etc. recognized in S200, a body shape and a seating status (specifically, whether or not there is a car seat for children, and the like) of the occupant are recognized. In S300, a result of the recognition in S290 is transmitted to the airbag control device 600, and then, the present process is ended.

As explained above, according to the posture determination device 20 of the present embodiment, the image of the occupant seated on the seat 2 is captured via the first antenna 12 and the second antenna 14 provided, respectively, in the seating section 4 and the backrest section 6 of the seat 2; based on the captured image, it is determined whether or not the posture of the occupant is a normal posture in which the airbag can be safely activated (S110 to S210).

As above, according to the posture determination device 20 of the present embodiment, unlike in a conventional device which monitors a posture of an occupant by means of a camera, it is not necessary to use light sources to image an occupant. Moreover, even when a shielding object is present between the occupant and the posture determination device 20, it is possible to image an occupant seated on the seat, thereby recognizing the posture of the occupant.

In the present embodiment, when the posture of the occupant is determined not to be a normal posture, not only an activation of the airbag is stopped but also an alarm is given to the occupant seated on the seat 2 (S220 to S240). This encourages the occupant to correct the posture, so as to reduce the number of times an activation of the airbag is stopped. As a result, improved safety while the vehicle is driving can be achieved.

Further, in the present embodiment, when it is determined that the posture of the occupant is normal, the image data of the headrest 8 via the third antenna 16 is obtained to recognize the head of the occupant. Based on the result of the recognition of the head and the result of the recognition of the shoulder width, the body shape and the seating status (specifically, whether or not there is a car seat for children, etc.) of the occupant is recognized. Then, the result of the recognition is transmitted to the airbag control device 600 (S250 to S300).

As above, according to the posture determination device 20 of the present embodiment, it is possible to configure the airbag control device 600 to control the airbag depending on the body shape and the seating status of the occupant, thereby further improving the safety.

The posture determination device for airbag of the present embodiment corresponds to a seating status detection apparatus of the present invention (specifically, the sixth aspect of the present invention). The first antenna 12, the second antenna 14, and the third antenna 16 correspond to an antenna device of the present invention. The processings of S120 to S150, S170 to S200, and S250 to S290 in the posture determination process of FIG. 5, correspond to a recognition device of the present invention. The processings of S160, S210 to S240, and S300 correspond to a posture determination device of the present invention.

### Second Embodiment

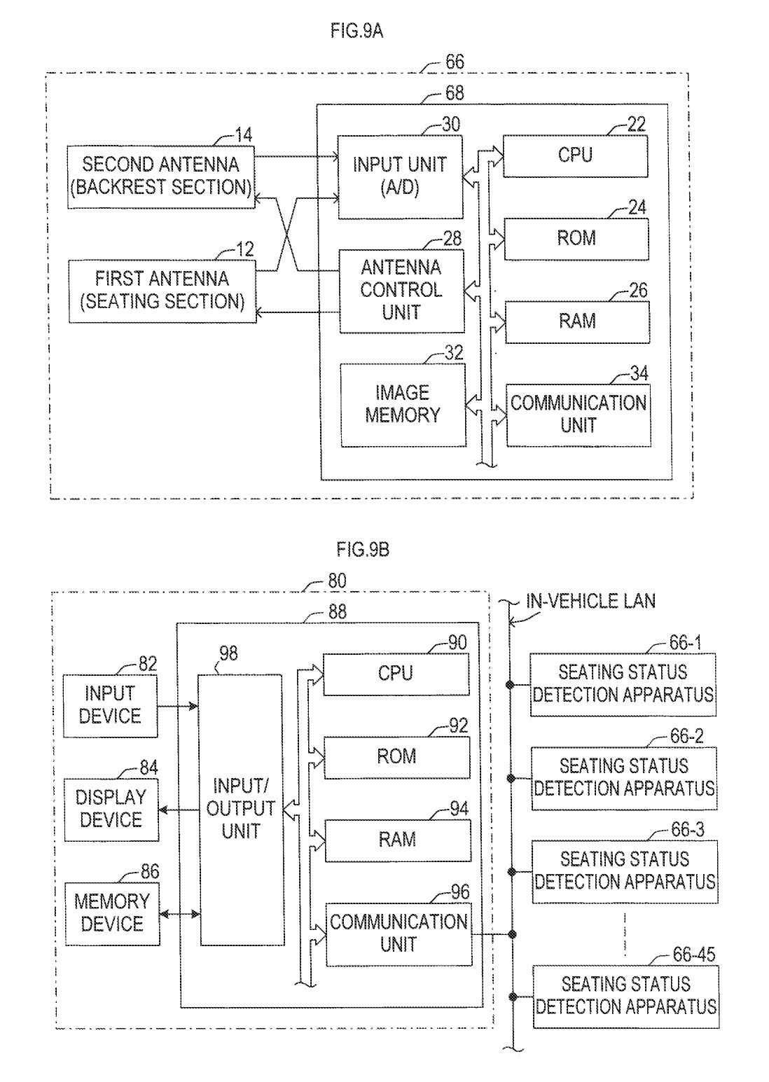

Next, the second embodiment of the present invention will be explained with reference to FIGS. 8 to 11.

In the present embodiment, an occupant monitoring system according to the seventh to the ninth aspects of the present invention is applied to a bus 72. As shown in FIG. 8, the occupant monitoring system includes a plurality of seating status detection apparatuses 66 and a monitoring apparatus 80. The seating status detection apparatus 66 is provided in each of a plurality of passenger seats (45 seats in the figure) 76 which are to be monitored in the bus 72. The monitoring apparatus 80 is provided at the frontward of a seat for a driver (i.e., driver's seat) who is an administrator of the bus 72.

As shown in FIG. 9A, the seating status detection apparatus 66 is provided with the first antenna 12, the second antenna 14, and a determination device 68. The first antenna 12 and the second antenna 14 are provided, respectively, in a seating section and a backrest section of the seat 76. The seating status detection apparatus 66 has the same configuration as that of the posture determination device for airbag in the first embodiment, except for the third antenna 16 which is not included in the seating status detection apparatus 66. The determination device 68 has the same configuration as that of the posture determination device 20 shown in FIG. 1.

As shown in FIG. 9B, the monitoring apparatus 80 is constituted of an input device 82, a display device 84, a memory device 86, and a control device 88. The input device 82 is to be used for inputting manipulation and arranged in such a manner that the driver can manipulate the input device 82 while being in the driver's seat 74. The display device 84 informs the driver of various information and includes a liquid crystal display, etc. The memory device 86 stores various information obtained from the seating status detection apparatus 66 and is comprised of a silicon disk, a hard disk, and others.

The control device 88 is constituted by a microcomputer which mainly includes a CPU 90, a ROM 92, a RAM 94, and a communication unit 96. The control device 88 is connected to the input device 82, the display device 84, and the memory device 86 via an input/output unit 98 as an interface.

The communication unit 96 of the control device 88 is connected in a manner that enables data communication to the seating status detection apparatus 66 (specifically, the communication unit 34 inside the determination device 68) provided in each of the seats 76 via an in-vehicle LAN (specifically, a communication line or a wireless communication line).

As above, the monitoring apparatus 80 can obtain information representing seating statuses of occupants in the respective seats 76, from the plurality of seating status detection apparatuses 66 (45 seats in the figure; specifically, 66-1, 66-2, . . . 66-45) provided in the respective seats 76, and can notify the driver of the obtained results via the display device 84.

Hereinafter, an explanation is given with regard to a control process that is executed to monitor occupants in the monitoring apparatus 80 and each of the detection devices 66 in the present embodiment constituted as above.

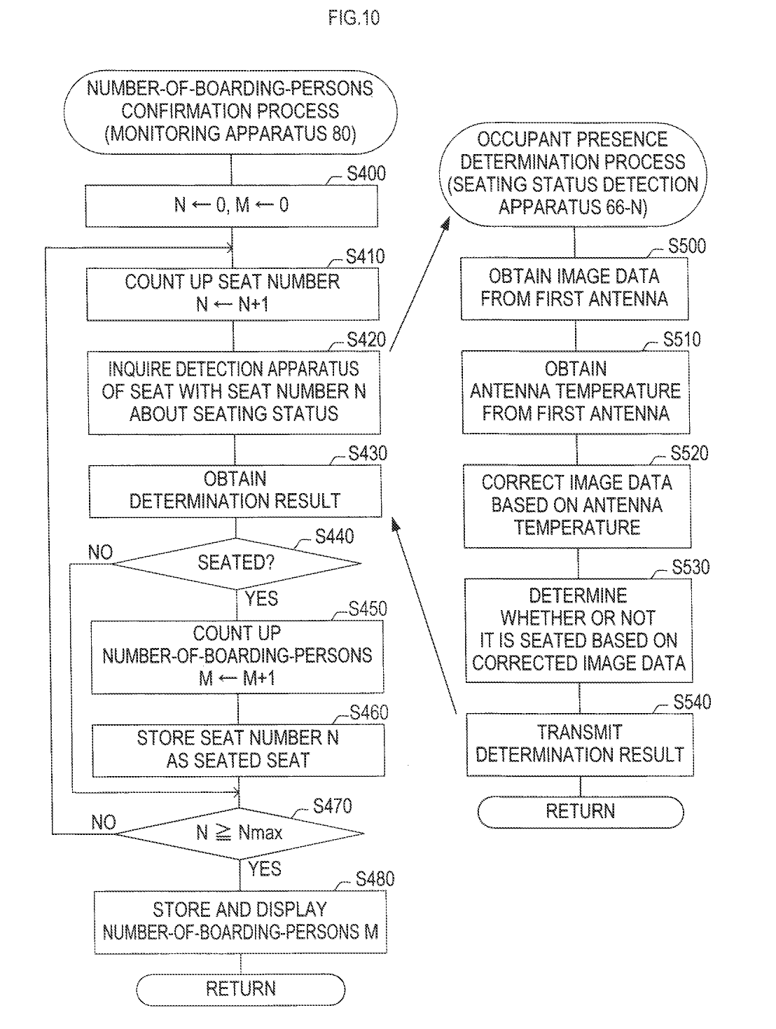

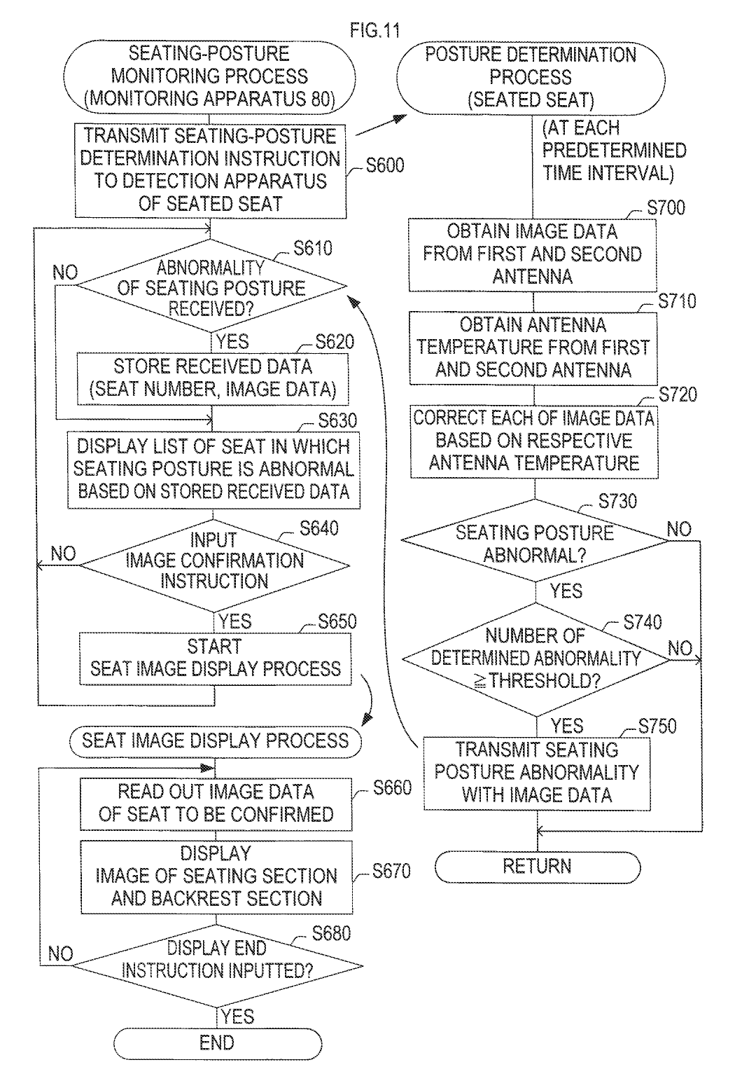

First, FIG. 10 shows a number-of-boarding-persons confirmation process, and an occupant presence determination process. When the driver inputs a number-of-boarding-persons confirmation instruction by manipulating the input device 82 of the monitoring apparatus 80, the number-of-boarding-persons confirmation process is executed by the control device 88 (specifically, the CPU 90) of the monitoring apparatus 80. When the number-of-boarding-persons confirmation process is executed, the occupant presence determination process is executed by the determination device 68 (specifically, the CPU 22) of the seating status detection apparatus 66 upon receipt of a request from the control device 88 (specifically, the communication unit 96) of the monitoring apparatus 80.

As shown in FIG. 10, when the number-of-boarding-persons confirmation process is executed by the number-of-boarding-persons confirmation instruction from the driver in the monitoring apparatus 80, first in S400, an initialization processing is performed. In the initializing processing, a value of a counter N which is to be used to count seat numbers in the subsequent processings and a value of a counter M which is to be used to count a number of boarding persons, are both set to an initial value of 0.

In the next S410, the counter N for the seat numbers is incremented (+1). Then, in the next S420, an inquiry signal is sent to a seating status detection apparatus 66-N of a seat 76-N with the number N corresponding to the incremented value of the counter N, from the communication unit 96 via the in-vehicle LAN. Thereby, an inquiry is made as to a seating status of an occupant in the seat 76-N with the number N (specifically, as to whether or not a passenger is seated).

Meanwhile, in the seating status detection apparatus 66-N of the seat 76-N with the number N, to which the inquiry signal has been sent from the monitoring apparatus 80, this inquiry signal is received by the communication unit 34 within the determination device 68. Then, the determination device 68 (specifically, the CPU 22) is made to start the occupant presence determination process.

When the occupant presence determination process is started by the determination device 68, first in S500, a control signal is outputted to the signal processor 46 of the first antenna 12 via the antenna control unit 28. Thereby, signal levels of the received signals from the respective antenna elements 10 constituting the first antenna 12 are sequentially received. The received signal levels are sequentially stored in the image memory 32. As a result, an image data, which is obtained from the first antenna 12, of the seating section 4 of the seat 76-N is stored.

In the next S510, a temperature of the first antenna 12 is obtained from the temperature sensor 48 provided in the first antenna 12. In the subsequent S520, based on the obtained antenna temperature, the image data stored in the image memory 32 is corrected. The processings in S510 and S520 are the same as those explained, respectively, in S120 and S130 of FIG. 5.

When the correction of the image data obtained by the first antenna 12 is completed in S520, it is determined in the next S530 whether or not a person is sitting on the seat 76-N with the number N based on the corrected image data. In the subsequent S540, a result of the determination is transmitted to the monitoring apparatus 80 from the communication unit 34 via the in-vehicle LAN.

In this occupant presence determination process, it is not necessary to determine a seating posture of an occupant; it is only necessary to determine whether or not a person is sitting on the seat 76. Therefore, in the present embodiment, an image data of the seating section 4 of the seat 76 is obtained from the first antenna 12, and based on the obtained image data, whether or not a person is seated is determined, in the above-explained processings of S500-S530.

However, the above determination of whether or not a person is seated can be made by determining whether or not thermal noise radiated from a person is received by the first antenna 12. Thus, it is not necessarily obtain all of the image data from the first antenna 12. Accordingly, it may be possible to determine whether or not a person is seated by obtaining received signals from some of (or one of) the antenna elements 10 constituting the first antenna 12.

After the result of the determination is transmitted in S540 in the determination device 68, the occupant presence determination process is terminated. Then, the process proceeds to a standby state to wait for a request from the monitoring apparatus 80.

As explained above, when an inquiry as to a seating status on the seat with the number N in the processing of S420 is made by the monitoring apparatus 80, it is then determined whether or not an occupant (passenger) is seated on the seat with the number N by the seating status detection apparatus 66-N of the seat with the number N. Then, a result of the determination is send to the monitoring apparatus 80.

For this reason, after the processing in S420 is executed at the monitoring apparatus 80, the present process proceeds to S430. In S430, the result of the determination is obtained from the seating status detection apparatus 66-N of the seat with the number N. In the next S440, based on the result of the determination, it is determined whether or not an occupant is seated on the seat 76-N with the number N.

When it is determined in S440 that the occupant is seated, in S450, a counter M for counting a number of boarding persons is incremented (+1) to count up the number of boarding persons. In the next S460, the seat number N is stored as a seated seat.

When either the seat number N is stored in S460 or it is determined in S440 that an occupant is not seated, the present process proceeds to S470. In S470, it is determined whether or not a value of the counter N for counting seat numbers is reached to a number of total passenger seats Nmax (45 seats in the present embodiment).

If the value of the counter N is not reached to the number of total seats Nmax, the present process proceeds to S410 to confirm whether or not a passenger is seated on a seat with the next seat number (N+1). On the other hand, when the value of the counter N is reached to the number of total seats Nmax, it is determined that a seating confirmation has been completed with respect to all of the seats and then, the present process proceeds to S480. In S480, the value of the counter M for counting a number of boarding persons is stored as a number of passengers (number of boarding persons) M riding in the bus in the memory device 86. In addition, the number of boarding persons M is displayed on the display device 84. Then, the number-of-boarding-persons confirmation process is terminated.

As explained above, the occupant monitoring system of the present embodiment is configured as follows: when the driver manipulates the input device 82 of the monitoring apparatus 80 to input a number-of-boarding-persons confirmation instruction, the monitoring apparatus 80 obtains seating information indicating whether or not a passenger is seated (i.e., a result of determination as to whether or not a person is seated) from the seating status detection apparatus 66 in each of the seats 76; then, a number of passengers riding in the bus 72 is counted based on the obtained seating information.

A result of the counting (number of boarding persons M) is displayed on the display device 84. Therefore, the driver can easily confirm the number of boarding persons M as passengers from a display screen of the display device 84 and, for example, confirm, before the bus 72 leaves, whether or not all passengers are on the bus 72.

Next, FIG. 11 shows a seating-posture monitoring process, a posture determination process, and a seat image display process. The seating-posture monitoring process is executed by the control device 88 (specifically, the CPU 90) of the monitoring apparatus 80 when the driver inputs a seating-posture monitoring instruction by manipulating the input device 82 of the monitoring apparatus 80. The posture determination process is executed by the determination device 68 (specifically, the CPU 22) of the seating status detection apparatus 66 upon receipt of a request from the control device 88 (specifically, the communication unit 96) of the monitoring apparatus 80 while the seating-posture monitoring process is executed. The seat image display process is executed when an image confirmation instruction is inputted by the driver while the seating-posture monitoring process is executed in the monitoring apparatus 80.

As shown in FIG. 11, when the seating-posture monitoring process is started in the monitoring apparatus 80 by the seating-posture monitoring instruction from the driver, first in S600, a seating-posture determination instruction is transmitted to the seating status detection apparatus 66 of a seated seat on which a passenger is sitting. The seated seat is identified based on a seat number N thereof which is stored in the memory device 86 in the number-of-boarding-persons confirmation process shown in FIG. 10.

Then, in the seating status detection apparatus 66 of the seated seat, the communication unit 34 receives the seating-posture determination instruction from the monitoring apparatus 80, to make the determination device 68 (specifically, the CPU 22) start the posture determination process.

After started, the posture determination process is executed in the determination device 68 at each predetermined time interval. When this process is started, first in S700, an image data is obtained from each of the first antenna 12 and the second antenna 14 via the antenna control unit 28, and stored in the image memory 32.

In the next S710, a temperature of each of the first antenna 12 and the second antenna 14 is obtained from the respective temperature sensors 48 provided in the first antenna 12 and the second antenna 14. In the subsequent S720, the image data, which is obtained from each of the first antenna 12 and the second antenna 14, stored in the image memory 32 is corrected based on the obtained antenna temperatures of the first antenna 12 and the second antenna 14.

These processings of S700-S720 are for generating image data of an occupant viewed from the seating section 4 and the backrest section 6 of the seat 76. The processings of S700-S720 are the same as those explained above of S120-140 and S170-190 in FIG. 5.

Next, in S730, whether or not the passenger is seated in a normal posture (e.g., upright and facing forward) in relation to the seat 76 is determined based on the image data, obtained in S720, of the occupant in the seating section 4 and the backrest section 6, by the following determination: for example, whether or not the occupant's hip or thighs are present in the seating section 4 and the occupant's back is present in the backrest section 6.

When it is determined in S730 that the passenger is seated in the normal posture (seating posture is normal), the present posture determination process is ended until the next timing when the present process starts after a predetermined time interval. On the other hand, when it is determined in S730 that the seating posture of the passenger is abnormal, the present process proceeds to S740. In S740, it is determined whether or not a number of times in which the seating posture is determined to be abnormal (number of determined abnormalities) reaches a predetermined threshold value (a plurality of times) (in other words, whether or not an abnormal state of the seating posture is continued for more than a predetermined time which is specified by the threshold value).

When the number of determined abnormalities dose not reach the predetermined threshold value, the present posture determination process is ended. On the other hand, when the number of determined abnormalities reaches the predetermined threshold value, the present process proceeds to S750. In S750, a seating posture abnormal signal is transmitted to the monitoring apparatus 80. The seating posture abnormal signal is a signal in which the information indicating abnormality of the seating posture is added with the image data of the occupant (image data in the seating section 4 and the backrest section 6) which is corrected in S720. Then, the present posture determination process is ended.

In this way, when the seating-posture determination instruction is transmitted to the seating status detection apparatus 66 of the seated seat from the monitoring apparatus 80 in S600, the posture determination process is repeatedly executed in the seating status detection apparatus 66. Thereby, whether or not the seating posture in relation to the seat 76 is normal is monitored.

Then, when the abnormal state of the seating posture is continued for more than a predetermined period of time, the fact that the abnormal state of the seating posture is continued for more than the predetermined period of time is notified to the monitoring apparatus 80.

As above, after the processing of S600 is executed in the monitoring apparatus 80, the present process proceeds to S610 to determine whether or not the seating posture abnormal signal transmitted from the seating status detection apparatus 66 is received by the communication unit.

When the seating posture abnormal signal is not received, the present process proceeds to S630. On the other hand, when the seating posture abnormal signal is received, in S620, received data included in the received signal, in other words, the image data in the seating section 4 and the backrest section 6 of the seat 76 as well as the seat number, are stored in the memory device 86; thereafter, the present process proceeds to S630.

In S630, based on the received data stored in the memory device 86, a list of seats, with regard to which the seating postures are determined to be abnormal at the respective seating status detection apparatuses 66, is displayed on the display device 84. In the subsequent S640, the driver manipulates the input device 82 to select a seat whose image is to be confirmed from the list of seats displayed on the display device 84; then, it is determined whether or not the image confirmation instruction has been inputted.

When the image confirmation instruction is not inputted, the present process proceeds to S610 to repeat a series of processings in the above S610-640. On the other hand, when the image confirmation instruction has been inputted, the seat image display process is started in S650. Thereafter, the present process returns to S610.

Next, the seat image display process started in S650 is executed in parallel with the seating-posture monitoring process in the control device 88 (specifically, the CPU 90) of the monitoring apparatus 80. When the seat image display process is started, the image data of the seat to be confirmed (a latest image data if there are a plurality of pieces of image data) is read out from the memory device 86 in S660. In S670, based on the read-out image data, an image of the occupant viewed from the seating section 4 and the backrest section 6 of the seat to be confirmed, is displayed on the display device 84.

In the next S680, it is determined whether or not a display end instruction is inputted from the driver. When the display end instruction is not inputted, the present process returns to S660 to display the image of the seat to be confirmed again. When the display end instruction has been inputted from the driver, the present seat image display process is terminated.

As explained above, the occupant monitoring system of the present embodiment is configured as follows: when the driver manipulates the input device 82 of the monitoring apparatus 80 to input a seating-posture monitoring instruction, the monitoring apparatus 80 transmits a seating-posture determination instruction to the seating status detection apparatus 66 of the seated seat on which the passenger is seated; thereby, the seating status detection apparatus 66 of the seated seat monitors the seating posture of the passenger.

Moreover, when the seating posture of the passenger is abnormal for more than a predetermined period of time, the seating status detection apparatus 66 transmits, to the monitoring apparatus 80, the seating posture abnormal signal indicating that the seating posture of the passenger is abnormal for more than the predetermined period of time. In the monitoring apparatus 80, based on this signal, the list of seats with regard to which the seating posture is determined to be abnormal is displayed on the display device 84.

Thus, the driver can identify the seat on which the passenger is not correctly seated based on the displayed image on the display device 84, thereby giving an alert to the passenger as necessary.

More specifically, in the present embodiment, after confirming the list of seats with regard to which the passengers' seating postures are abnormal, the driver requests a display of the image of the seat of concern. In this case, the image of the occupant captured from the seating section 4 and the backrest section 6 of the seat, respectively, by the first antenna 12 and the second antenna 14 of the same seat is displayed on the display device 84. Therefore, the driver can confirm whether or not an occupant's seating posture is abnormal by looking at the displayed image with own eyes, before giving an alert to the passenger.

Moreover, the driver inputs the image confirmation instruction to the monitoring apparatus 80 and confirms the captured image of the passenger's seating status in the seat of concern. In this case, when the seating status is abnormal, the seat image display process is continuously executed so as to update the displayed image with the image data transmitted from the seating status detection apparatus 66 of the subject seat. Thereby, a change in the seating status can be monitored. Furthermore, when the driver determines that there is no problem in the passenger's seating status as a result of confirming the image, it is possible to specify the subject seat and delete the received data of the subject seat stored in the memory device 86.

Although one embodiment of the present invention has been described above, the invention should not be limited to the above embodiment, but can be practiced in various manners without departing from the scope of the invention.

For example, in the above embodiment, it is described that the plurality of antenna devices (12, 14, and 16) are provided in different positions (the seating section 4, the backrest section 6, the headrest 8, etc.) of the seat 2 or 76, thereby recognizing a seating posture or a body shape, etc. of an occupant. However, it is possible to provide either the first antenna 12 or the second antenna 14 in the seating section 4 or the backrest section 6 to recognize a seating posture of an occupant by the captured image. Moreover, if it is only necessary to determine whether or not an occupant is seated on a seat, it may be possible to provide one antenna element 10 in the seating section 4 or the backrest section 6 of the seat 7 (76).

In the above embodiment, it is described that the antenna devices (12, 14, and 16) are a planar antenna in which the antenna elements 10 are arranged in a two-dimensional array on the flexible substrate and this planar antenna is provided inside of the seat 2. However, it may be possible to, for example, arrange a hard planar antenna on a body portion (such as a door) next to the seat 2 to image the occupant from a lateral side of the seat 2, and recognize the posture of the occupant. It may be also possible to provide an antenna on a ceiling or a pillar of a vehicle and image the occupant from above the seat 2 or diagonally frontward from the seat 2, thereby recognizing the posture of the occupant.

When the antenna is provided on the ceiling or the pillar of the vehicle as above, there may be a long distance between the antenna and the occupant. Therefore, it would be preferable to provide a dielectric lens in front of each of the antenna elements, or a parabolic reflector behind each of the antenna elements, so that a beam width of each of the antenna elements can be narrowed, thereby increasing antenna gain.

In the above embodiment, one detector 45 is provided since it is configured that received signals from the plurality of the antenna elements 10 are inputted to the detector 45 via the selector 44. However, a plurality of the detectors 45 may be provided in a downstream of each of the BPF 43 and the respective antenna elements 10 within the IC 60, so that detection signals (wave detection voltage) are outputted to the signal processor 46 from each of the detectors 45. When configured as above, the selector 44 would become unnecessary. Also, in this case, since it is not necessary to provide the switching signal line 58 for transmitting switching signals to the antenna substrate, the design of the antenna devices (12, 14, and 16) can be simplified.

Moreover, for example, it may be configured that the IC 60, which is to be connected to each of the antenna elements 10, may be composed only of the selector 44, and that one received signal selectively outputted via the selector 44 is inputted to the detector 45 via the LNA 42 and BPF 43. When configured as above, it is sufficient to provide only one LNA 42, one BPF 43, and one detector 45 in relation to one antenna device (12, 14, and 16). Consequently, it is possible to simplify the circuit configuration.

Furthermore, in the above embodiment, it is described that the temperature sensor 48 is provided within each of the antennas 12, 14, and 16. However, it may be possible to provide the temperature sensor inside of a vehicle; in this case, based on a temperature inside the vehicle detected by the temperature sensor, the image data obtained via each of the antennas 12, 14, and 16 may be corrected.

Although the above embodiment describes the present invention which is applied to an automobile, the present invention may be applied to an airplane, a train, a ship, etc, as long as it is a moving body, in the same manner as in the above embodiment.

1. A seating status detection apparatus comprising:
an antenna element that receives thermal noise radiated from an occupant seated on a seat in a moving body; and
a recognition device that recognizes the occupant seated on the seat based on a reception level of the thermal noise received by the antenna element.

2. The seating status detection apparatus according to claim 1, comprising an antenna device in which a plurality of the antenna elements are arranged in a planar manner;
wherein the recognition device recognizes a posture of the occupant seated on the seat based on the reception levels of the thermal noises received by the plurality of antenna elements.

3. The seating status detection apparatus according to claim 2,
wherein the antenna device is installed in at least one of a seating section, a backrest section, and a headrest of the seat.

4. The seating status detection apparatus according to claim 2,
wherein the antenna device is constituted of a planar antenna in which the plurality of antenna elements are arranged in a distributed manner on a flexible substrate, and is provided between an occupant-side surface fabric of the seat and a cushion material inside of the seat.

5. The seating status detection apparatus according to one of claim 2, comprising a posture determination device that determines whether or not the posture of the occupant recognized by the recognition device is within a predetermined normal range, and notifies, when the posture of the occupant is not in the predetermined normal range, the occupant or an external device that the posture of the occupant is not in the predetermined normal range.

6. The seating status detection apparatus according to claim 5,
wherein the posture determination device determines whether or not the posture of the occupant recognized by the recognition device is a normal posture which allows an airbag provided for the seat to be safely activated,
transmits a signal that permits an operation of the airbag to an external airbag control device device when the posture of the occupant is the normal posture, and
transmits a signal that inhibits the operation of the airbag to the airbag control device when the posture of the occupant is not the normal posture.

7. An occupant monitoring system for a moving body provided in a moving body to monitor statuses of occupants riding in the moving body, the system comprising:
the seating status detection apparatus according to claim 1, provided in each of a plurality of seats to be seated by occupants to be monitored; and
a monitoring apparatus provided for an administrator of the moving body, the monitoring apparatus obtaining results of recognition of the occupants from the recognition devices, each constituting each of the seating status detection apparatuses, in accordance with an input command from the administrator, and notifying the administrator of the obtained results.

8. The occupant monitoring system for a moving body according to claim 7,
wherein the monitoring apparatus is capable of measuring a number of occupants riding in the moving body based on the results of recognition obtained from the recognition devices of the respective seating status detection apparatuses in accordance with the input command from the administrator, and notifying the administrator of a result of the measurement.

9. The occupant monitoring system for a moving body according to claim 7, wherein the seating status detection apparatus for each seat of the plurality of seats comprises an antenna device in which a plurality of antenna elements are arranged in planar manner, and wherein the recognition device for each seat recognizes a posture of the occupant seated on that seat based on the reception levels of the thermal noises received by the plurality of antenna elements of the antenna device for that seat,
wherein the monitoring apparatus is capable of obtaining seating postures of the occupants on the seats on which the occupants are seated, from the recognition devices of the respective seating status detection apparatuses in accordance with the input command from the administrator, and notifying the administrator of the obtained seating postures.
